(19) United States
(12) Patent Application Publication
(10) Pub. No.: US 2021/0278004 A1
(43) Pub. Date: Sep. 9, 2021

(54) Reduced Profile Valve Body

(71) Applicant: Bray International, Inc., Houston, TX (US)

(72) Inventors: William Karlen, Cypress, TX (US); Partha Chinnasamy, Katy, TX (US)

(21) Appl. No.: 17/193,178

(22) Filed: Mar. 5, 2021

Related U.S. Application Data
(60) Provisional application No. 62/985,833, filed on Mar. 5, 2020.

(51) Int. Cl. F16K 27/02; F16K 1/22

(52) U.S. Cl. CPC F16K 27/0218; F16K 1/22

(57) ABSTRACT

The disclosure relates to an improved valve for controlling a flow through a throughbore of the valve, including a valve body having a front face and a back face, and an outer surface defined on a side of the valve body, wherein the outer surface connects the front face and the back face of the valve body; a plurality of recesses defined in the outer surface and the back face, wherein the plurality of recesses are not defined in the front face; and a plurality of ribs between the plurality of recesses on the side of the valve body, wherein the plurality of ribs are integral with the front face and terminate at the back face.

### BACKGROUND

Technical field: The disclosure relates to improvements for valves and valve assemblies, and in particular butterfly valve and valve assemblies.

There is a need for butterfly valve assemblies that are lightweight, utilize less manufacturing material, and which feature improved performance, control and flow characteristics.

### BRIEF SUMMARY OF THE EMBODIMENTS

The disclosure relates to an improved valve for controlling a flow through a throughbore of the valve, including a valve body having a front face and a back face, and an outer surface defined on a side of the valve body, wherein the outer surface connects the front face and the back face of the valve body; a plurality of recesses defined in the outer surface and the back face, wherein the plurality of recesses are not defined in the front face; and a plurality of ribs between the plurality of recesses on the side of the valve body, wherein the plurality of ribs are integral with the front face and terminate at the back face.

As used herein, the terms “rotational,” “rotating,” “rotatably”, or the like in regard to movement or motion shall refer to movement around or about an axis, as defined by the valve stem of the valve system.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a perspective view of an exemplary embodiment of a reduced profile valve body.

FIG. 2 depicts a rear view of an exemplary embodiment of a reduced profile valve body.

FIG. 3 depicts a front view of an exemplary embodiment of a reduced profile valve body.

FIG. 4 depicts a side view of an exemplary embodiment of a reduced profile valve body.

FIG. 5 depicts a bottom view of an exemplary embodiment of a reduced profile valve body.

FIG. 6 depicts a perspective view of an exemplary embodiment of a reduced profile valve assembly.

FIG. 7 depicts a rear view of an exemplary embodiment of a reduced profile valve assembly.

FIG. 8 depicts a front view of an exemplary embodiment of a reduced profile valve assembly.

FIG. 9 depicts a front perspective view of an exemplary embodiment of a reduced profile valve assembly as installed between pipe flanges of a piping system.

FIG. 10 depicts a side view of an exemplary embodiment of a reduced profile valve assembly as installed between mating pipe flanges of a piping system.

FIG. 11 depicts a front view of an exemplary embodiment of a reduced profile valve assembly as installed between pipe flanges of a piping system.

FIG. 12 depicts a front view of an exemplary embodiment of a reduced profile valve assembly as installed between pipe flanges of a piping system.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

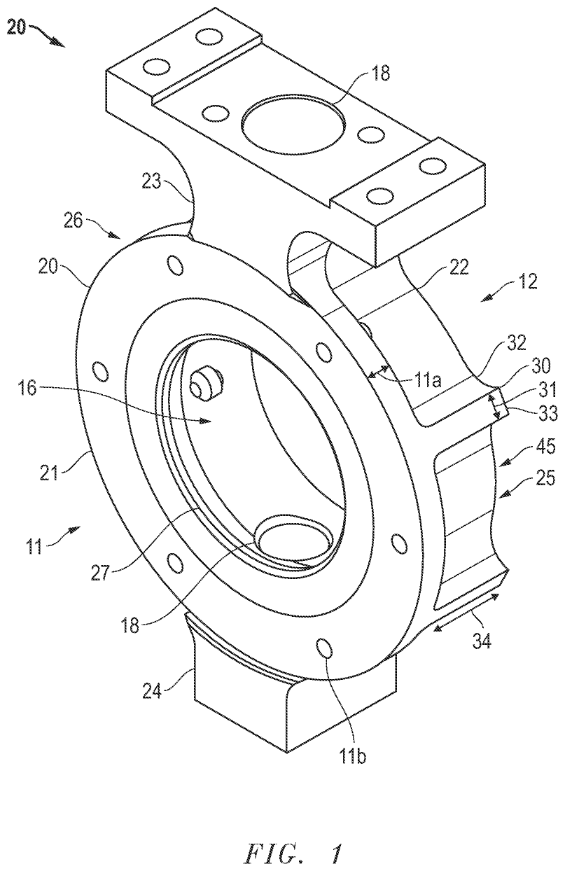

The FIGS. 1-5 depict various views of an exemplary embodiment of a reduced profile valve body 20 of an improved wafer-type butterfly valve or valve assembly 10, for insertion into a pipe system (not illustrated) for control of a media flow. Although the exemplary embodiments herein refer to improvements as applied to a wafer-type butterfly valve, the disclosure may be applied to a variety of other types of valve bodies, including, and not to be limited to, lug style valve bodies. The reduced profile valve body 20 may have a substantially cylindrical shape having an outer surface or wall 26 and an inner surface or inner diameter 27 defining a through bore or bidirectional (or bi-directional) opening 16. The valve 10 and body 20 also have a front face or flange 11 and a rear or back face 12. The outer surface or wall 26 may connect the front face 11 and rear face 12 along the sides 45 of the valve body 20.

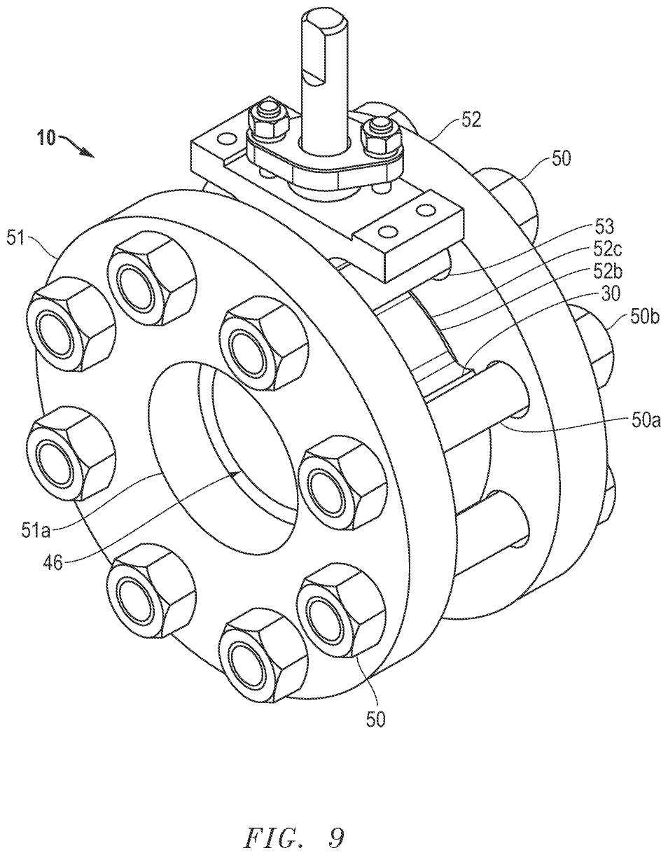

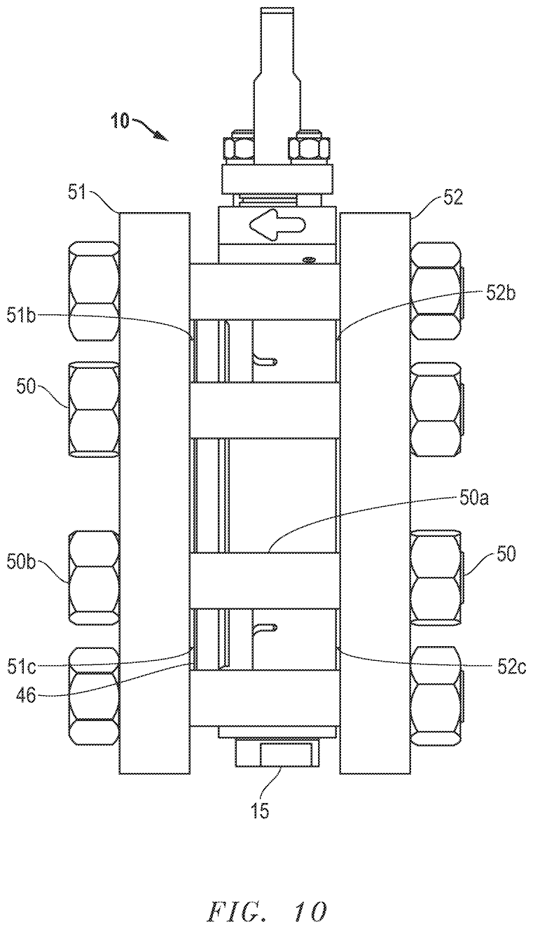

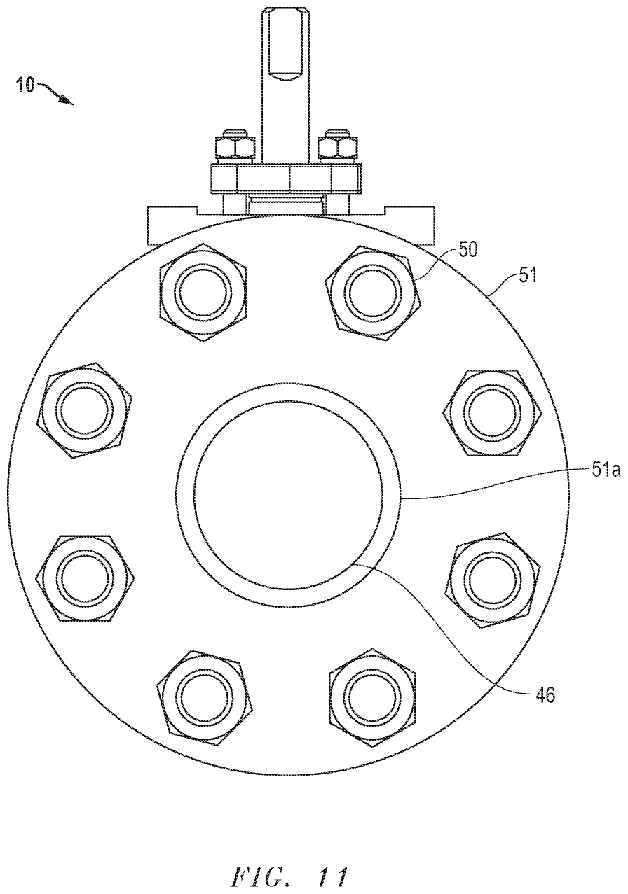

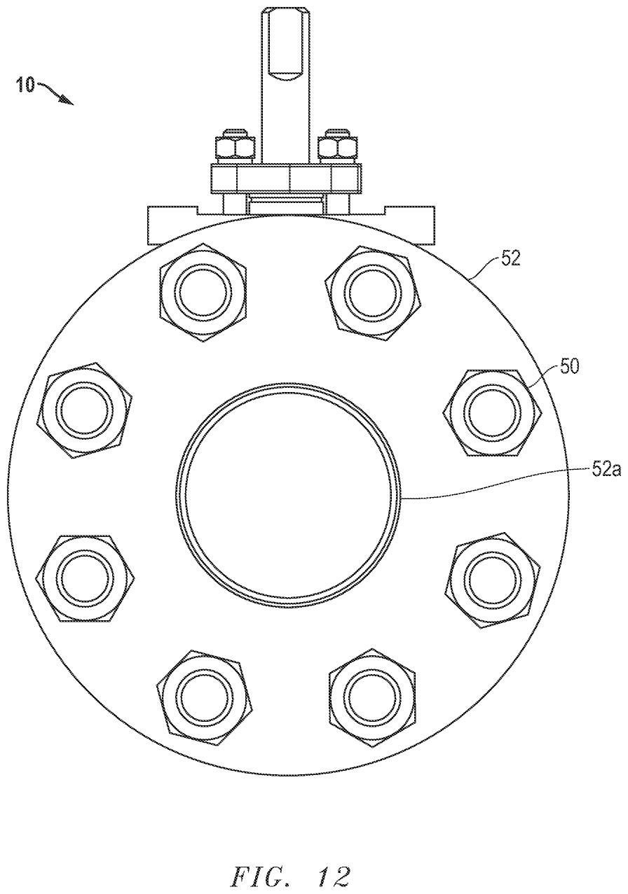

The front flange or face 11 of reduced profile valve body 20 defines an outer diameter or profile 21 and the rear face 12 of the reduced profile valve body 20 defines an outer diameter or profile 22. The front face 11 connects with the flange of the front mating pipe 51 at the front of the valve (see, e.g. FIGS. 9-12). The front face 11 may include a seat retainer 46. The seat retainer 46 may be situated or located between the front face 11 and the front pipe flange 51, wherein the seat retainer 46 is secured to the front face 11 with seat retainer fasteners 47 as engaged with seat retainer holes 11 b defined near the outer diameter 21 of the front face 11. Alternatively, the fasteners 47 may also be installed from the rear side of the face 11 (see e.g. curved surface 62 or adjacent to or extending from surface 62) to secure the retainer 46. The size of the outer diameter or profile 21 of the front face 11 is determined or dictated by the front mating pipe's flange 51 pattern of flange stud holes 53 for the flange studs 50. The front face outer diameter 21 should preferably be small enough for the flange studs 50 to pass without interfering with the valve 10 (e.g. the outer diameter 21 may be smaller than the area or pattern defined by the flange stud holes 53). The back face 12 outer diameter 22 connects or mates with a raised surface 52b flange (wherein raised surface 52b may also include a flange gasket for sealing) of a rear mating pipe flange 52. The flange gasket (not illustrated) of the raised surface 52b may be located between the raised surface 52b and the rear face 12 when valve 10 is assembled into a pipe or piping system. Similarly, the raised surface 51b of the front pipe flange 51 may also include another flange gasket (not illustrated), when the valve 10 is assembled into a pipe or pipe system environment, wherein the flange gasket may be located between the raised surface 51b and the seat retainer 46. Raised surfaces or raised face flanges 51b, 52b are merely one type of exemplary embodiment of flange faces, other flange facings are considered within the scope of the disclosure, such as by way of example and not to be limited to flat faces, ring type joints, tongue and groove, male and female and others as known to one of ordinary skill in the art. The outer diameter 22 of the rear face 12 is determined or dictated by the outer diameter 52c of the raised surface 52b of flange of the rear mating pipe 52, such that the outer diameter 22 of the back face 12 is equivalent (or substantially the same or similar) to outer diameter 52c of the raised flange surface 52b of the rear mating pipe flange 52.

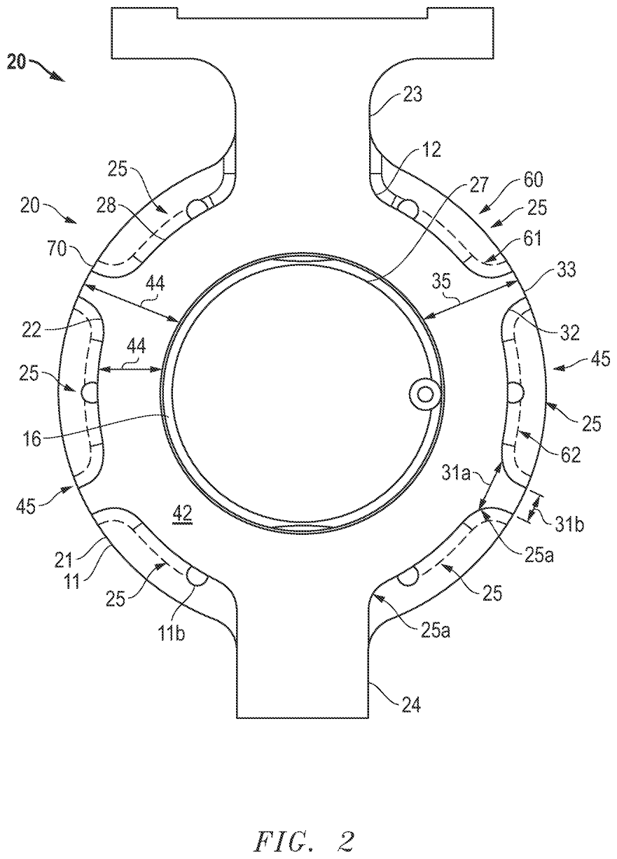

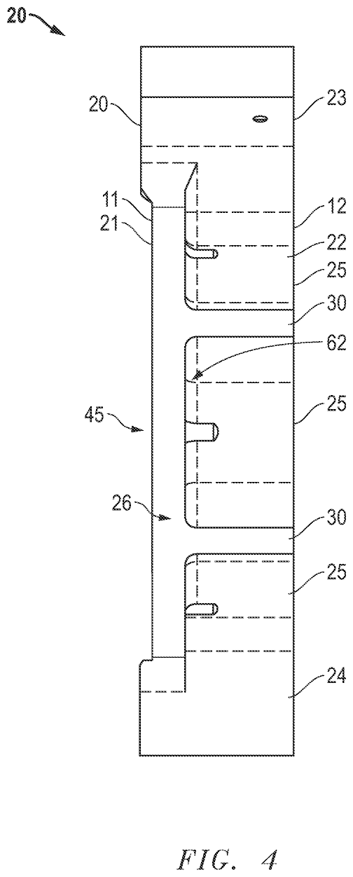

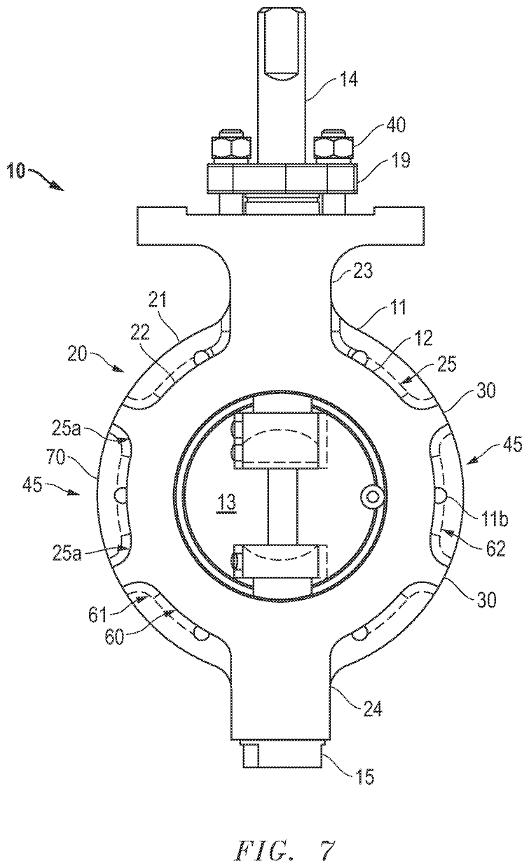

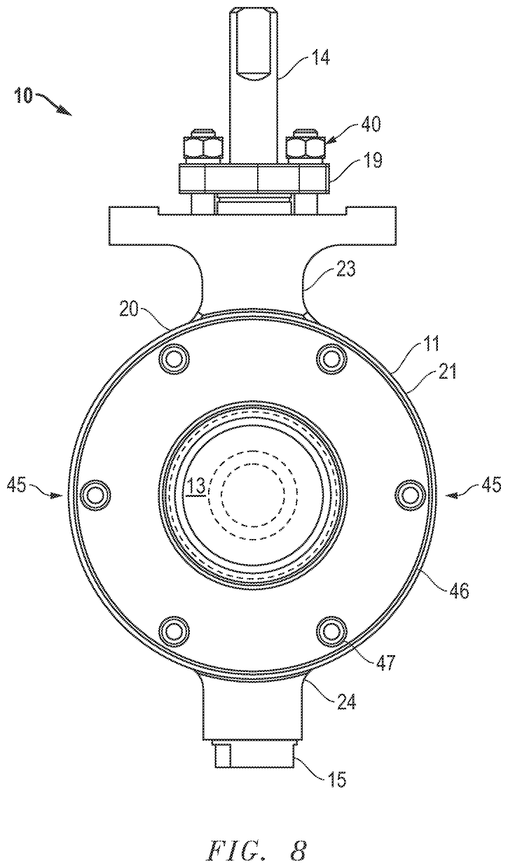

The inner surface or inner diameter 27 of the valve body 20 may have an identical sized opening 16 on both the front flange or face 11 and back/rear face 12. The valve body 20 has a plurality of scallops, valleys, recesses, indentations, slots, notches or partial openings 25 carved out, cut out, removed or otherwise defined in the wall 26 and in the rear/back face 12 and outer diameter or profile 22, thus reducing or decreasing the surface area 42 of the outer diameter or profile 22 at the rear face 12 (as compared to the greater surface area 41 of the outer diameter or profile 21 of the front face or flange 11). Scallops 25 may be defined primarily on or along the sides 45 of the valve body 20. On the sides of the valve body 20, the plurality of scallops 25 may be adjacent to ribs 30 between each end of the scallop 25. Scallops 25 located near the top and bottom of the valve body 20 may have one end adjacent to the upper neck 23, or the lower neck 24 of the valve 10 or valve body 20, respectively (see FIGS. 2 and 4), instead of being adjacent to ribs 30 on both ends of the scallop 25. Scallops or recesses 25 may also have a base 28. The base 28 may include a curvature, curved surfaces or rounded corners 25a adjacent to and transitioning into the bottom of the ribs 30. Similarly, the base 28 may include a rounded shoulder, curvature, or curved surface 62 transitioning to a face parallel to the front face 11. As depicted, the plurality of scallops 25 are of identical size on the valve body 20, although in alternative exemplary embodiments, the plurality of scallops 25 may have varying sizes on a valve body 20. The front flange 11 may have a thickness 11a adjacent to each scallop 25. The scallops or cut-outs 25 are not defined through, cut/carved out, or removed from the front flange or face 11 or outer diameter 21 in the exemplary embodiments depicted in FIGS. 1-12; although in further alternative exemplary embodiments, the scallops 25 may be defined in both the front face 11 and rear face 12.

The recesses or scallops 25 are voids, cavities, or hollows 60 defined the in the valve body 20. In one exemplary embodiment, the voids 60 geometrically have a scallop (e.g. a series of curved segments in two and/or three dimensions) shape. The geometric shape also has the appearance of half-bean shaped hollows in segments in (as appearing in two and/or three dimensions) around the typical circumference 70 of the valve body 20. The voids 60 are arcuate or curved reduced radius or diameter sections 61 having rounded shoulders 25a. The voids 60 terminate at the rounded shoulders 25a which transition to or are contiguous with the ribs 30 (or contiguous with the upper neck 23 or lower neck 24 at one end as the case may be), and terminate at the front flange or face 11 (have thickness 11a) which may also have a curved shoulder 62 of the valve body 20. The voids 60 are equidistantly spaced between the upper neck 23 and the lower neck 24 around the typical circumference 70 of the valve body 20. The ribs 30 and face 11 are unitary or integral to the valve body 20. In another exemplary embodiment the voids 60 may be defined as sections of reduced diameter recesses or troughs interposed between ribs 30, face 11, upper neck 23, and lower neck 24.

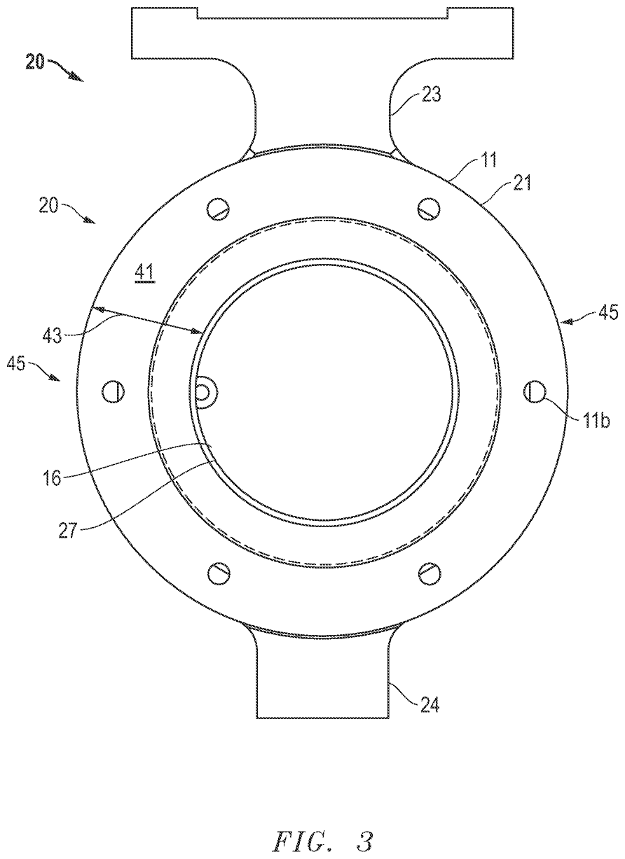

The distance between the inner diameter 27 and the outer diameters 21 and 22 may each be defined as the radius, or radial distances 43 and 44, respectively. The front radius, profile radius or radial distance 43 of the front face or flange 11, as best seen on FIG. 3, is the distance between the inner diameter 27 and the outer diameter 21, and is a constant measurement, length or value at any point of the sides 45 of the outer surface or wall 26 of the valve body 20. The rear radius, profile radius or radial distance 44 of the rear face 12, as best seen on FIG. 2, is the distance between the inner diameter 27 and the outer diameter 22, and has a variable measurement, length or value along the sides 45 of the outer surface or wall 26 of the valve body 20 as a result of the indentation or removal of material by scallops 25. At any point along the outer surface or wall 26, the measurement, length or value of the rear radius 44 will be equal to or less than the measurement, length or value of the front radius 43. The radiuses 43 and 44 may be substantially the same or similar at the top 33 of the ribs 30, and also at the upper neck 23 and lower neck 24.

The ribs 30 each have a bottom 32 which is located closer to the center or bore 16 of the valve body 20, and a top 33 which is located farther away (compared to the bottom 32) from the center of valve body 20 or the bore 16 (see e.g. FIG. 2). The ribs 30 each have a thickness 31 that may vary between the bottom 32 and the top 33 of the rib 30. In the exemplary embodiments depicted in the FIGS. 1-8, the thickness 31a at the rib bottom 32 may be greater than the thickness 31b at the rib top 33. Further, in certain exemplary embodiments the thickness 31b at the top 33 may be the same or similar to thickness 11a of the front flange 11 (other thicknesses deviating from the thickness 11a of the front flange 11 are considered within the scope of the disclosure). However, alternative thicknesses 31, 31a and 31b are considered within the scope of the disclosure. For example, in certain alternative exemplary embodiments the thickness 31a and 31b may be identical; in further alternative exemplary embodiments, the thickness 31a at the bottom 32 may be less than the thickness 31b at the top 33. The ribs 30 may also have a length 34 (see FIG. 1) and a height 35 (see FIG. 2). The length 34 of the rib 30 is the distance between the front face 11 and the rear face 12, of which the rib 30 extends the full distance of. The height 35 of the rib 30 is the radial distance between the inner diameter 27 or the bore 16, and the outer wall or outer surface 26. The height 35 of the rib 30 is identical, the same or similar at both the front flange or face 11 and the rear face 12. The plurality of ribs 30 may be integral or integrated with, and connected to the front face 11 and terminate at the back face 12.

Although as depicted in the FIGS. 1-8, there are four (4) ribs 30 and six (6) scallops 25, it is considered within the scope of the disclosure to embody any number of ribs 30 and scallops 25. As the size of the valve 10 increases, additional ribs 30 and scallops or recesses 25 are expected to be included on the valve body 20.

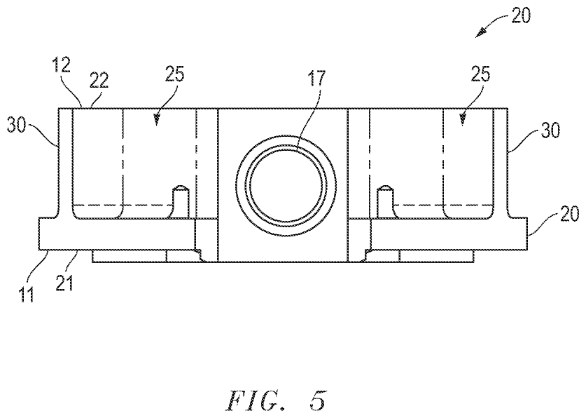

The valve body 20 may further define stem openings 18 through the upper neck 23 and lower neck 24, and a locating plug opening 17 on the underside of the valve body 20, as can be best observed in FIGS. 1 and 5. The locating plug opening 17 may be connected to the stem opening 18 defined in the lower neck 24.

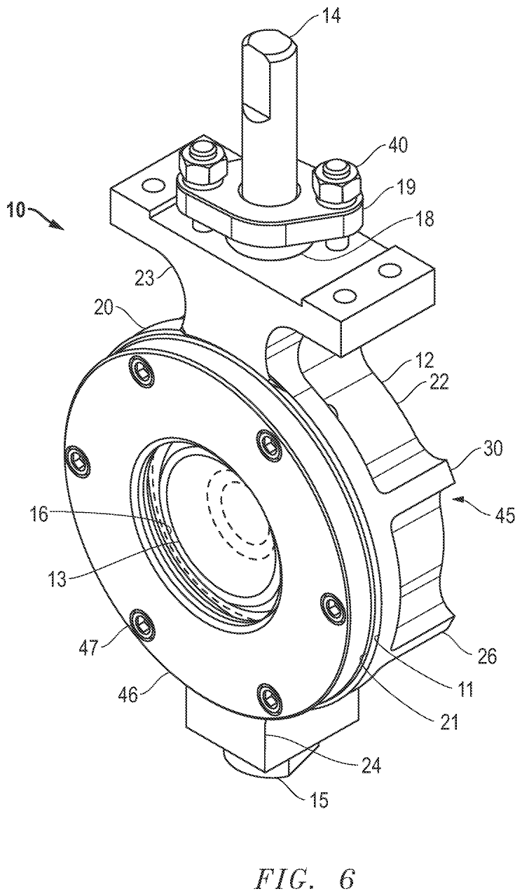

As depicted in FIGS. 6-8, the valve assembly 10, as assembled, includes the valve body 20, a disc, disk or control element 13, a stem (or stem pieces) 14, a gland retainer 19 and a locating plug 15 installed onto the valve body 20. The stem 14 is inserted through the gland retainer 19 and the stem openings 18 in the upper neck 23 and lower neck 24 of the valve body 20. The stem 14 is further connected to the disc 13 in the bore 16, while allowing for rotational movement of the stem 14. The gland retainer 19 may be secured to the upper neck 23 of the valve body 20 via fasteners 40. The disc or control element 13 is inserted within the throughbore 16 while allowing for rotational movement. Although the disc 13 and stem (or stem pieces) 14 are depicted in FIGS. 6-8 as a two-piece disc-stem configuration, in alternative exemplary embodiments, the disc-stem may be a singular, unitary or one-piece disc-stem configuration; a standard disc-stem configuration; or any other disc-stem configuration as known to one of ordinary skill in the art. Rotational manipulation of the stem 14 along its axis via a valve actuator (not illustrated) above the valve body 20 transmits the rotational movement from the stem 14 to the disc 13. As the disc 13 rotates or pivots in the bore 16, any media flowing through the bore 16 can be controlled via the position of the disc 13. The valve 10 as pictured in FIGS. 6-8 depicts the disc 13 in a closed position, thus preventing any flow of media through the bore 16. A locating plug 15 inserted into the locating plug opening 17 may be adjacent to the stem or stem piece 14 located in the lower neck 24 stem opening 18. The locating plug 15 may also have reduced height to meet dimensional requirements.

FIGS. 9-12 depict various views of exemplary embodiments of the valve assembly 10 as inserted between a front mating pipe flange 51 and a rear mating pipe flange 52. The front mating pipe flange 51 and rear mating pipe flange 52 may each define flange openings 51a, 52a (respectively) which correspond similarly or substantially with the disk bore or opening 16 of the improved valve body 20. The front mating pipe flange 51 may be raised with a raised face 51b and engages with the seat retainer 46 (wherein the raised face 51b may include a flange gasket for sealing) as secured to the front face 11 of the valve body 20. Raised face 51b may have an outer diameter 51c. The rear mating pipe flange 52 may also be raised with a raised face 52b and engages with the rear face 12 (wherein the raised face 52b may include a flange gasket for sealing) of the improved valve body 20. Raised face 52b may have an outer diameter 52c, wherein the reduced profile 22 on the rear face 12 matches the outer diameter 52c of the rear mating pipe flange raised face 52b. Each mating pipe flange 51, 52 may also define a series of pipe flange stud holes 53 about the perimeter of each pipe flange 51, 52. Each pipe flange stud holes 53 on the front pipe flange 51 and on the rear pipe flange 52 may be aligned such that the shank 50a of a flange stud (or other type of fastener) 50 may be inserted into a flange stud hole 53 on the front pipe flange 51 and into a flange stud hole 53 on the rear pipe flange 52 and secured. The flange stud 50 may optionally include a bolt, a shank, or a body 50a and a nut or head 50b; other fasteners 50 as known to one of ordinary skill in the art are considered included within the present disclosure. The bodies 50a of a number of the flange studs 50 may be situated or located adjacent to the top of the ribs 30a; the remaining flange studs 50 and their corresponding bodies 50a may be located to the sides of the upper neck 23 and the lower neck 24 when assembled in an exemplary embodiment. Alternative exemplary embodiments include differing placements of the flange studs 50 so long as the bodies 50a are positioned outside of outer surface 22 or wall 26.

Manufacture or production of the improved reduced profile valve body 20 may be accomplished by a variety of methods, including machining a wafer-type valve body 20 from a plate, which in certain exemplary embodiments may be a titanium plate (although other materials are possible and considered included within the scope of this disclosure), and creating/defining scallops 25 in the outer wall surface 26 by removing plate material from the outer wall 26 of the valve body 20, while leaving material in the outer wall 26 to form ribs 30 with a rib thickness 31 and a front flange 11 having a thickness 11a. The reduced profile valve body 20 may also be produced by casting or injecting material into a mold having the desired shape of an improved reduced profile valve body 20, wherein the mold includes scallops 25 and ribs 30, thus minimizing the raw materials and cost of manufacture. Despite the expected materials savings, the reduced profile valve body 20 and valve assembly 10 meets or exceeds needs for structural integrity requirements for wafer-type butterfly valves including, at least: valve body deflection and valve body stress limitations. The improved valve 10 and valve body 20 are also lighter weight than conventional valves and valve bodies.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any valve system or assembly used for piping systems, including for exhaust valve systems. Additionally, although the valve assembly 10 as depicted in the figures is a 2.5″ double offset butterfly valve, the improvements upon valve assembly 10 may be used on any size of valve and may also be applied to triple offset butterfly valves. Moreover, the figures included within this disclosure depict merely some exemplary embodiments. The performance and features mentioned in this disclosure will be the same.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An improved valve for controlling a flow through a throughbore of the valve, comprising:
a valve body comprising a front face and a back face, and an outer surface defined on a side of the valve body, wherein the outer surface connects the front face and the back face of the valve body;
a plurality of recesses defined in the outer surface and the back face, wherein the plurality of recesses are not defined in the front face; and
a plurality of ribs between the plurality of recesses on the side of the valve body, wherein the plurality of ribs are integral with the front face and terminate at the back face.

2. The improved valve of claim 1, further comprising a front outer diameter defined by the front face; and a back outer diameter defined by the back face; and wherein the front outer diameter is larger than the back outer diameter.

3. The improved valve of claim 2, wherein the plurality of ribs each have a thickness which is variable, and wherein the thickness is greater near a bottom of the plurality ribs closer to a center of the valve as compared with the thickness of the rib near a top of the plurality of ribs farther away from the center of the valve.

4. The improved valve of claim 3, wherein the plurality of ribs comprise four ribs, and wherein the plurality of recesses comprise six recesses.

5. The improved valve of claim 3, wherein the front face comprises a front face thickness, and wherein the front face thickness and the rib thickness at the top of the plurality of ribs are the same.

6. The improved valve of claim 5, further comprising an inner surface of the throughbore, and a front profile radius defined as the distance between the inner surface and the front outer diameter, wherein the front profile radius is constant at all points of the front outer diameter on the front face.

7. The improved valve of claim 6, further comprising a rear profile radius defined as the distance between the inner surface and the back outer diameter, wherein the rear profile radius is variable along the back outer diameter on the back face.

8. The improved valve of claim 7, wherein the rear profile radius is the same as the front profile radius at the top of the plurality of ribs.

9. The improved valve of claim 8, wherein the plurality of recesses are of substantially identical size.

10. An improved valve for controlling a flow through a throughbore of the valve, comprising:
a valve body comprising a front face and a back face, and an outer surface defined on a side of the valve body, wherein the outer surface connects the front face and the back face of the valve body;
a plurality of recesses defined in the outer surface and the back face, wherein the plurality of recesses are not defined in the front face;
a plurality of ribs between the plurality of recesses on the side of the valve body, wherein the plurality of ribs are integral with the front face and terminate at the back face; and
a front outer diameter defined by the front face; and a back outer diameter defined by the back face; and wherein the front outer diameter defines a larger surface area than the back outer diameter.

11. The improved valve of claim 10, further comprising a base of the plurality of recesses, wherein the base transitions to the plurality of ribs and the front face via curved surfaces.

12. The improved valve of claim 11, further comprising a seat retainer located on the front face.

13. A method of controlling a fluid flow, comprising the steps of:
providing a valve body comprising a front face and a back face, and an outer surface defined on a side of the valve body connecting the front face and the back face of the valve body, and wherein the outer surface has a plurality of recesses defined in the outer surface and the back face, wherein the plurality of recesses are not defined in the front face, and further wherein the outer surface defines a plurality of ribs between the plurality of recesses on the side;
connecting the front face to a seat retainer; and
actuating a disk in a bore of the valve body.

14. The method according to claim 13, wherein the front face comprises a front outer diameter and the back face comprises a back outer diameter, and wherein the front outer diameter is larger than the back outer diameter.

15. The method according to claim 14, wherein the plurality of ribs connect the front face to the back face along the outer surface.

16. The method according to claim 15, wherein each of the plurality of ribs define a top of the rib and a bottom of the rib, and a height in between the top of the rib and the bottom of the rib, and further wherein each of the plurality of ribs have a thickness which is variable along the height of the rib.

17. The method according to claim 16, wherein the height of the plurality of ribs at the front face is the same as the height of the plurality of ribs at the back face.
